(19) United States
(12) Patent Application Publication
(10) Pub. No.: US 2019/0187065 A1
(43) Pub. Date: Jun. 20, 2019

(54) LIGHTING APPARATUS, METHOD FOR PROVIDING LIGHTING SYSTEM, AND ROAD MANAGEMENT SYSTEM

(71) Applicant: PANASONIC INTELLECTUAL PROPERTY MANAGEMENT CO., LTD., Osaka (JP)

(72) Inventors: Yoshiyuki TAKAHIRA, Kyoto (JP); Shojiro KIDO, Osaka (JP); Toshiya MORIWAKI, Osaka (JP); Kenichiro TANAKA, Osaka (JP)

(73) Assignee: PANASONIC INTELLECTUAL PROPERTY MANAGEMENT CO., LTD., Osaka (JP)

(21) Appl. No.: 16/221,059

(22) Filed: Dec. 14, 2018

(30) Foreign Application Priority Data
Dec. 19, 2017 (JP) 2017-242333

(51) Int. Cl. G01N 21/88; F21V 15/01; B60R 1/00

(52) U.S. Cl. CPC G01N 21/8806; G01N 21/8851; F21V 15/01; F21W 2131/101; G01N 2021/8861; B60R 2300/102; B60R 1/00

(57) ABSTRACT

A lighting apparatus that irradiates light on a vehicle is provided. The lighting apparatus includes: a first light source that emits light for illuminating a predetermined area; a memory that stores location information indicating a location of the lighting apparatus; a second light source that outputs, to the predetermined area, a light signal indicating the location information; and a first controller that controls the first light source and the second light source, and modulates the light signal output by the second light source, in accordance with the location information stored in the memory.

### CROSS REFERENCE TO RELATED APPLICATION

This application claims the benefit of priority of Japanese Patent Application Number 2017-242333 filed on Dec. 19, 2017, the entire content of which is hereby incorporated by reference.

### BACKGROUND

### 1. Technical Field

The present disclosure relates to a lighting apparatus, a method for providing a lighting system, and a road management system.

### 2. Description of the Related Art

Conventionally, in the measurement of the state of deterioration of a wall surface inside a tunnel on a road, deterioration points are detected by a vehicle traveling inside the tunnel. Specifically, there is disclosed an apparatus that inspects the surface of a road structure and includes: a wall surface illuminator that irradiates a wall surface with beam along the traveling direction of the vehicle; and a wall-surface image capturing unit that includes a line sensor and captures images of a wall surface (see reference to Japanese Unexamined Patent Application Publication No. 2014-95627).

This apparatus that inspects the surface of a road structure identifies defects that have occurred on a wall surface inside a tunnel, by capturing images of the wall surface while the vehicle is made to travel in the tunnel.

### SUMMARY

In the case of installing the aforementioned apparatus in a train, for example, since a railroad track is fixed, it is possible to correctly identify the location of the train based on the track (one dimension) distance (i.e., length of the railroad track) from a reference position, and this enables inspection starting from the same position under the same conditions each time the inspection is conducted. In the case of installing the aforementioned apparatus in a vehicle traveling on a road, however, it is possible to roughly determine, based on video presenting a wall surface inside a tunnel, how far in meters from the entrance of the tunnel the video was actually captured, but it is difficult to accurately identify deterioration points on the wall surface inside the tunnel. This is because, due to vehicle's moving two-dimensionally on the road, the vehicle travels at a position different in the width direction of the road each time the vehicle travels on the road. Accordingly, it is required, in some cases, to identify deterioration points by visual examination and mark the points, eventually, and therefore, improvement in workability has been demanded.

In view of the above, the present disclosure has an object to provide a lighting apparatus, a method for providing a lighting system, and a road management system, with which it is possible to improve the workability of the work for identifying deterioration points on at least one of a road or a facility adjacent to the road.

In order to achieve the above-described object, a lighting apparatus according to one aspect of the present disclosure is a lighting apparatus that irradiates a vehicle with light and includes: a first light source that emits light for illuminating a predetermined area; a memory that stores location information indicating a location of the lighting apparatus; a second light source that outputs, to the predetermined area, a light signal indicating the location information; and a first controller that controls the first light source and the second light source, and modulates the light signal output by the second light source, in accordance with the location information stored in the memory.

Moreover, a method for providing a lighting system according to one aspect of the present disclosure includes: providing a plurality of the lighting apparatus along a road at predetermined intervals along a traveling direction of the vehicle; and outputting, by each of the plurality of the lighting apparatus, identification information which identifies the lighting apparatus and is stored in the memory, to the predetermined area via the second light source.

Moreover, a road management system according to one aspect of the present disclosure includes: the lighting apparatus; a camera that is in the vehicle and captures an image of a surrounding area of the vehicle; and a third light source that generates flaw location information which identifies a flaw location on at least one of a road or a facility adjacent to the road, by irradiating at least one of the road or the facility adjacent to the road with laser light while the vehicle travels on the road.

According to the present disclosure, it is possible to improve the workability of the work for identifying deterioration points on at least one of a road or a facility adjacent to the road.

### BRIEF DESCRIPTION OF DRAWINGS

The figures depict one or more implementations in accordance with the present teaching, by way of examples only, not by way of limitations. In the figures, like reference numerals refer to the same or similar elements.

FIG. 1 is a schematic diagram illustrating the case where a measuring vehicle, lighting apparatuses, and a road are viewed in the traveling direction of the measuring vehicle in a road management system according to Embodiment 1;

FIG. 2 is a schematic diagram illustrating the case where the measuring vehicle, the lighting apparatuses, and the road are viewed in a direction perpendicular to the traveling direction of the measuring vehicle in the road management system according to Embodiment 1;

FIG. 3 is an exploded perspective view illustrating a lighting apparatus according to Embodiment 1;

FIG. 4 is a plan view illustrating the lighting apparatus according to Embodiment 1;

FIG. 5 is a block diagram illustrating the road management system according to Embodiment 1;

FIG. 6 is a sequence chart illustrating operations performed by the road management system according to Embodiment 1;

FIG. 7 is a sequence chart illustrating operations performed by a road management system according to Embodiment 2; and

FIG. 8 is a schematic diagram illustrating the case where the measuring vehicle, the lighting apparatuses, and the road are viewed in the traveling direction of the measuring vehicle in a road management system according to a variation.

### DETAILED DESCRIPTION OF THE EMBODIMENTS

The following describes embodiments according to the present disclosure with reference to the drawings. Note that the embodiments described below each show a preferred, specific example of the present disclosure. The numerical values, shapes, materials, elements, the arrangement and connection of the elements, steps, order of the steps, etc. indicated in the following embodiments are mere examples, and therefore do not intend to limit the scope of the present disclosure. Therefore, among elements in the following embodiments, those not recited in any of the broadest, independent claims are described as optional elements.

Note that the drawings are presented schematically and are not necessarily precise illustrations. In addition, like reference signs indicate like elements in the drawings, and overlapping descriptions of like elements are omitted or simplified.

The following describes the lighting apparatus, method for providing a lighting system, and road management system according to the embodiments of the present disclosure.

### Embodiment 1

### (Configuration)

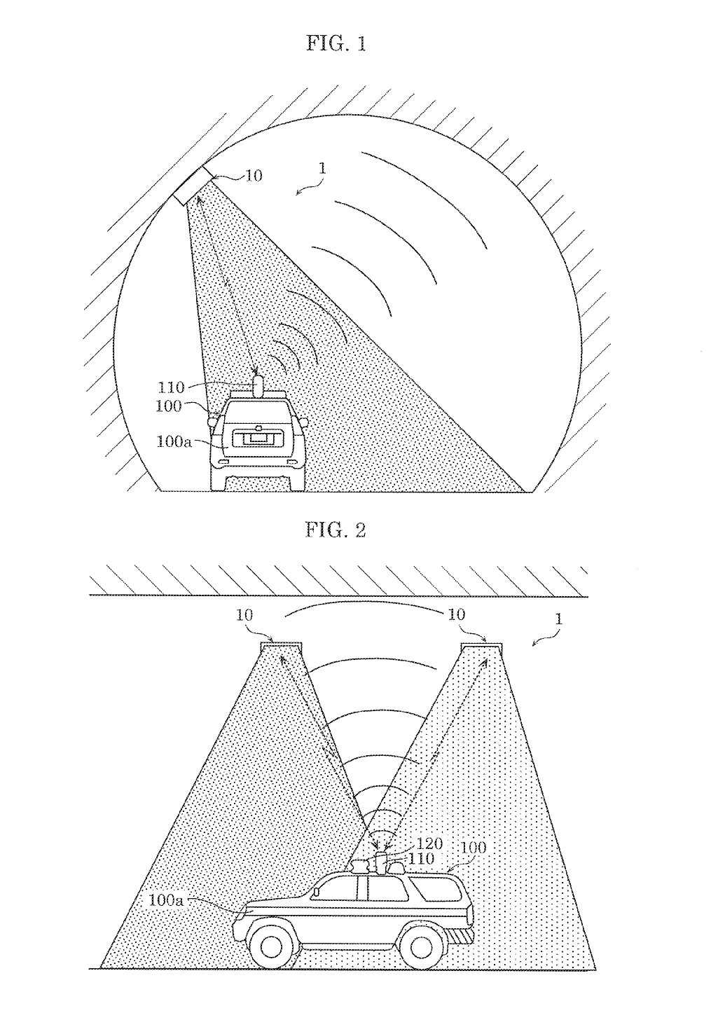

FIG. 1 is a schematic diagram illustrating the case where measuring vehicle 100, lighting apparatuses 10, and a road are viewed in the traveling direction of measuring vehicle 100 in road management system 1 according to Embodiment 1. FIG. 2 is a schematic diagram illustrating the case where measuring vehicle 100, lighting apparatuses 10, and the road are viewed in a direction perpendicular to the traveling direction of measuring vehicle 100 in road management system 1 according to Embodiment 1.

As illustrated in FIG. 1 and FIG. 2, road management system 1 is a system for detecting the state of deterioration both of the road on which measuring vehicle 100 travels and of a facility provided along the road. Road management system 1 includes lighting apparatus 10 and measuring vehicle 100.

### (Lighting Apparatus)

Lighting apparatus 10 irradiates, with light, measuring vehicle 100 that detects the state of deterioration of at least one of a road or a facility adjacent to the road. The road is, for example, a pavement or a railroad track for measuring vehicle 100 to travel. The facility adjacent to the road is, for example, the inner wall of a tunnel or a windbreak wall provided along a road.

A plurality of lighting apparatuses 10 are installed along the road. In this embodiment, lighting apparatuses 10 are installed on the inner wall of a tunnel at a predetermined height relative to a road surface and at predetermined intervals along the traveling direction of measuring vehicle 100. It should be noted that the height and intervals at which lighting apparatuses 10 are installed need not be identical among lighting apparatuses 10. Each of lighting apparatuses 10 is installed to emit light for illuminating a predetermined area in the tunnel, and outputs a light signal that indicates identification information and location information which indicates the location of lighting apparatus 10. The inner wall of a tunnel is one example of a facility adjacent to a road.

The location information is information, such as latitude and longitude, which indicates an absolute location of lighting apparatus 10. Moreover, the location information according to this embodiment includes a distance from the entrance or exit of a tunnel, a height from a road surface, etc. Additionally, the location information shall not be limited to latitude and longitude etc., and may indicate a relative location in a tunnel, on a road, etc. In other words, the location information may indicate a relative location which is a location relative to the entrance or exit of a tunnel, a road surface, etc. The identification information is unique information for identifying each of lighting apparatuses 10.

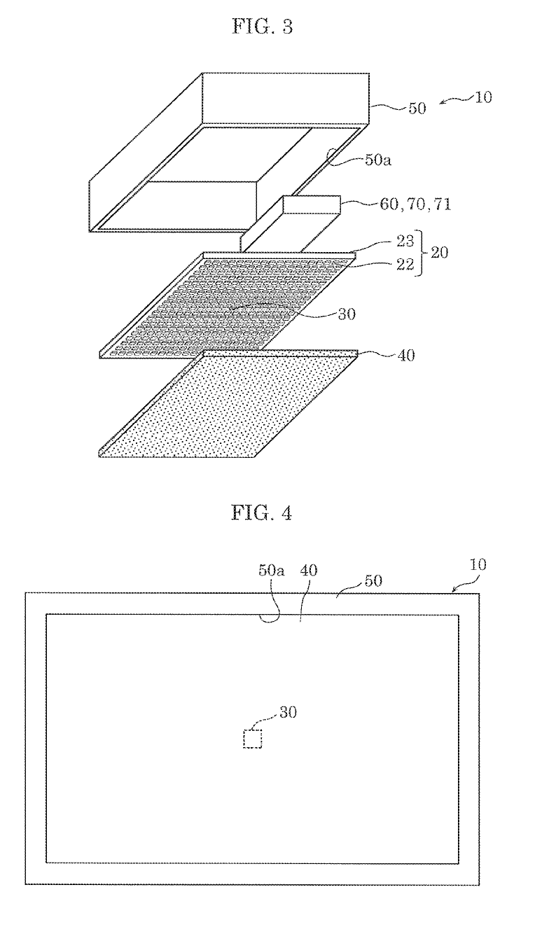

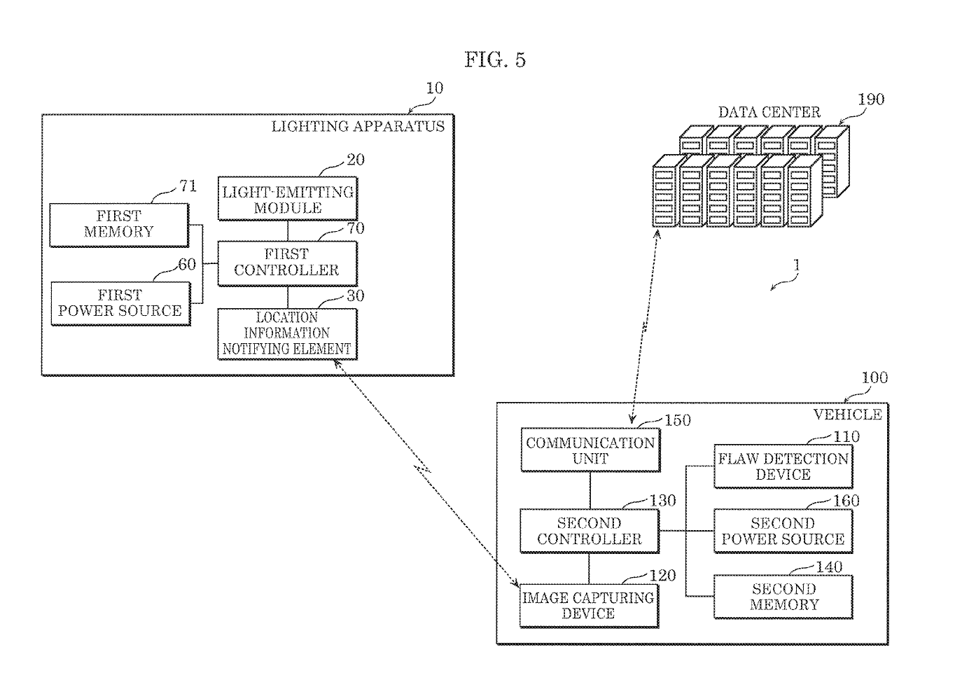

FIG. 3 is an exploded perspective view illustrating lighting apparatus 10 according to Embodiment 1. FIG. 4 is a plan view illustrating lighting apparatus 10 according to Embodiment 1. FIG. 5 is a block diagram illustrating road management system 1 according to Embodiment 1.

As illustrated in FIG. 3 and FIG. 5, lighting apparatus 10 includes housing case 50, light-transmissive panel 40, light-emitting module 20, location information notifying element 30, first controller 70, first memory 71, and first power source 60.

Housing case 50 is a housing that houses light-emitting module 20, location information notifying element 30, first controller 70, first memory 71, and first power source 60. As illustrated in FIG. 3, housing case 50 has opening 50a which is a face that is opened and through which light passes. Housing case 50 is one example of the housing. Opening 50a is one example of an illumination window.

Housing case 50 is a planar box having a substantially rectangular shape in a plan view. It should be noted that the shape of housing case 50 shall not be particularly limited to a substantially rectangular shape, and may be a substantially circular, polygonal, or semicircular shape.

Housing case 50 includes, for example, a non-metallic material that has high thermal conductivity or a metallic material. The non-metallic material having high thermal conductivity is, for example, resin having high thermal conductivity. By using such material having high thermal conductivity for housing case 50, it is possible to dissipate outside, via housing case 50, heat generated by light-emitting module 20.

Light-transmissive panel 40 is fixed to opening 50a of housing case 50 so as to cover opening 50a of housing case 50. Light-transmissive panel 40 transmits and emits light emitted by light-emitting module 20. More specifically, light-transmissive panel 40 transmits light that is incident on the light incidence surface of light-transmissive panel 40, which is a face of light-transmissive panel 40 on the side of light-emitting module 20, and emits the light from the light emission surface of light-transmissive panel 40. When housing case 50 is viewed in a plan view, the shape of light-transmissive panel 40 is in accordance with the shape of housing case 50. Light-transmissive panel 40 may include an illumination window. In this embodiment, light-transmissive panel 40 has a substantially rectangular shape, but the shape shall not be particularly limited to such and may be a substantially circular, polygonal, or semicircular shape.

Light-emitting module 20 is a module that emits light for illuminating a predetermined area. Light-emitting module 20 is disposed substantially parallel to light-transmissive panel 40. Light-emitting module 20 is one example of the first light source.

Light-emitting module 20 includes substrate 23 and LED elements 22 disposed on substrate 23.

Substrate 23 is a printed wiring board for having LED elements 22 disposed thereon and has a substantially rectangular shape. For example, a resin-based substrate, a metal-based substrate, or a ceramic substrate may be used as substrate 23.

LED elements 22 are disposed on substrate 23. LED elements 22 are disposed, for example, (in a matrix) in a plane on substrate 23. LED elements 22 are disposed, for example, at evenly spaced intervals on substrate 23. LED element 22 may also be one example of a light source.

LED elements 22 are formed by light emitting diode (LED) elements. LED elements 22 each emit white light. In this embodiment, LED element 22 may be an RGB-type LED element that emits blue, green, or red light. It should be noted that LED element 22 may be an LED element of surface mount device (SMD) type or of chip on board (COB) type, or of bullet type, and optical components such as mirrors and lenses may be attached therewith. The colors of light emitted by LED element 22 shall not be limited to three colors of RGB and may be four colors of RGBW or two colors of BW (blue and white).

Moreover, signal lines for transmitting control signals from lighting apparatus 10 and power lines for supplying power from first power source 60 are provided on substrate 23, although not shown in the diagram. The signal lines and power lines, for example, connect LED elements 22 in series. Each of LED elements 22 receives power supplied from first power source 60 via the power lines, and emits predetermined light based on a control signal transmitted through the signal lines.

Location information notifying element 30 outputs, to a predetermined area, a light signal indicating location information. Moreover, location information notifying element 30 also outputs, to a predetermined area, a light signal indicating identification information which identifies each of lighting apparatuses 10 and is stored in first memory 71. Location information notifying element 30 is one example of the second light source.

The light signal output by location information notifying element 30 passes light-transmissive panel 40 and is output to a predetermined area. The light signal includes modulated light that has been modulated in accordance with the location information and modulated light that has been modulated in accordance with the identification information. In this embodiment, the light signal that is output by location information notifying element 30 is an infrared light signal. Infrared light has a wavelength of, for example, from 780 nm to 980 nm.

It should be noted that the light signal shall not be limited to infrared light and may be visible light. In the case where visible light is used for the light signal, it is possible to enhance the S/N ratio of the light signal by using, for the light signal, light having a spectral shape different from that of light illuminating a road. In the case where infrared light is used for the light signal, it becomes easy to install and use lighting apparatus 10 in a place such as a place other than a tunnel, an outside place where pole lamps are provided in the environment where sunlight becomes noise.

As illustrated in FIG. 3 and FIG. 4, location information notifying element 30 is disposed on substrate 23 of light-emitting module 20. When opening 50a is viewed in a plan view, location information notifying element 30 is disposed at the center of opening 50a, that is, at the center of substrate 23. Stated differently, when opening 50a is viewed in a plan view, location information notifying element 30 is disposed at the center of opening 50a.

As illustrated in FIG. 5, first controller 70 controls light-emitting module 20 and location information notifying element 30, and modulates a light signal output by location information notifying element 30, in accordance with the location information stored in first memory 71. In other words, first controller 70 controls operations such as turning on and off of light-emitting module 20 to cause light-emitting module 20 to illuminate a predetermined area, and causes location information notifying element 30 to output, to a predetermined area, a light signal indicating the location information stored in first memory 71. Moreover, first controller 70 has a light emission control circuit that converts power supplied from a commercial power source into direct current power suitable for light-emitting module 20, and that outputs the direct current power. The light emission control circuit includes, for example: a constant current circuit for supplying light-emitting module 20 and location information notifying element 30 with a constant current; and a modulation circuit for modulating current supplied from the constant current circuit. The modulation circuit includes a switching element for modulating the current supplied to light-emitting module 20.

First controller 70, for example, reads the location information stored in first memory 71 and controls, in accordance with the location information that has been read, on and off switching by the switching element included in the modulation circuit in the light emission control circuit. With this, since current supplied from first controller 70 to light-emitting module 20 is modulated, first controller 70 is capable of causing location information notifying element 30 to emit modulated light modulated in accordance with location information. The modulated light blinks at a speed human eyes cannot recognize, for example, in the range from several kHz to several MHz.

It should be noted that first controller 70 controls location information notifying element 30, and modulates a light signal output by location information notifying element 30, in accordance with identification information stored in first memory 71. The description on the operation of first controller 70 in connection with the identification information is identical to that provided above in connection with the location information.

First memory 71 stores location information indicating the location of each lighting apparatus 10 and identification information which identifies each lighting apparatus 10 and corresponds to the location information. In the case of installing lighting apparatuses 10 in a facility, the location of each lighting apparatus 10 may be determined in advance. The location information indicating the location of each lighting apparatus 10 may be previously stored in first memory 71. In this case, each lighting apparatus 10 may be installed in a location that has been predetermined for the installation of lighting apparatuses 10. First memory 71 is one example of a memory.

It should be noted that the location information indicating the location of each lighting apparatus 10 may be directly input to lighting apparatus 10 after the installation of lighting apparatus 10. In this case, lighting apparatus 10 may include an input receiver that receives an input of location information or a communication unit that obtains location information from a terminal device. The communication unit in this case is a wireless communication module used for wireless communication for receiving the location information of lighting apparatus 10 from the terminal device.

Moreover, first memory 71 stores a control program to be executed by first controller 70, or the like. More specifically, first memory 71 is realized by a semiconductor memory or the like.

First power source 60 is a component that converts, by means of rectification, smoothing, power reduction, etc., alternating current power supplied from a commercial power source into direct current power having a predetermined level, and that supplies light-emitting module 20 with the direct current power.

### (Measuring Vehicle)

Measuring vehicle 100 is a vehicle that is equipped, for example, with flaw detection device 110 and image capturing device 120, and that detects, while traveling on a road, the state of deterioration of at least one of the road or a facility adjacent to the road through laser irradiation of at least one of the road or the facility by flaw detection device 110 and also through capturing of images of laser irradiated parts by image capturing device 120. Measuring vehicle 100 is one example of a vehicle.

Measuring vehicle 100 includes body 100a, flaw detection device 110, image capturing device 120, second controller 130, second memory 140, communication unit 150, and second power source 160.

Body 100a is, for example, the body of a vehicle. Flaw detection device 110, image capturing device 120, second controller 130, second memory 140, communication unit 150, and second power source 160 are equipped in body 100a. Flaw detection device 110 and image capturing device 120 are provided, for example, on the roof panel or front bumper of body 100a, and this allows flaw detection device 110 to detect deterioration points on at least one of the road or the facility adjacent to the road and also allows image capturing device 120 to capture images of the road and the facility.

Flaw detection device 110 generates flaw location information which identifies a flaw location on at least one of the road or the facility adjacent to the road, by irradiating at least one of the road or the facility with laser light while measuring vehicle 100 travels on the road. Flaw detection device 110 irradiates, with laser light, for example, a road such as a pavement, and a facility adjacent to the road, such as the inner wall of a tunnel or a windbreak wall. In this embodiment, flaw detection device 110 emits laser light in a direction substantially perpendicular to the traveling direction of measuring vehicle 100. While measuring vehicle 100 moves in the traveling direction, flaw detection device 100 scans, with laser light, at least one of the road or the facility adjacent to the road. Thus, flaw detection device 110 generates flaw location information indicating a flaw location on at least one of the road or the facility adjacent to the road, and this allows the user to recognize the location of a deteriorating part. A flaw location is a deterioration point which correctly indicates the location of a deteriorating part of at least one of the road or the facility adjacent to the road, and thus indicates an absolute location of the deteriorating part. Flaw detection device 110 is one example of the third light source.

Image capturing device 120 is equipped in measuring vehicle 100 and captures images of the surrounding area of measuring vehicle 100 while measuring vehicle 100 travels on the road, for example. Image capturing device 120 is capable of capturing images at 360 degrees around measuring vehicle 100. Image capturing device 120 outputs, to second controller 130, video presenting the surrounding area of measuring vehicle 100, which includes images of lighting apparatuses 10, the location information of each lighting apparatus 10, and the identification information of each lighting apparatus 10. Image capturing device 120 is a camera that has an image sensor and captures images of the surrounding area of measuring vehicle 100 based on control performed by second controller 130. By using the image sensor, image capturing device 120 is capable of recognizing, as location information and identification information, a light signal (modulated light) emitted by location information notifying element 30. It should be noted that image capturing device 120 may store, in second memory 140, the location information of each lighting apparatus 10, the identification information of each lighting apparatus 10, and information indicating video presenting the surrounding area of measuring vehicle 100, by outputting them to second memory 140.

Flaw location information includes information such as latitude and longitude indicating a flaw location. Moreover, the flaw location information according to this embodiment includes, for example, a distance from the entrance of a tunnel to a flaw location, a height from a road surface to the flaw location, a distance from each of at least two lighting apparatuses 10 to the flaw location, etc.

Second controller 130 identifies the location of lighting apparatus 10 based on identification information which identifies lighting apparatus 10 and is obtained by image capturing device 120. In other words, second controller 130 obtains location information and identification information via image capturing device 120, and associates location information received from one of lighting apparatuses 10 with identification information received from that lighting apparatus 10. Thus, second controller 130 identifies the location of lighting apparatus 10. It should be noted that second controller 130 may store, in second memory 140, the location information and identification information of each lighting apparatus 10.

Moreover, second controller 130 identifies the location of measuring vehicle 100 based on the location information of at least two lighting apparatuses 10 and the video that presents lighting apparatuses 10 and is captured by image capturing device 120. By calculating an angle of view based on the video that presents lighting apparatuses 10 and is captured by image capturing device 120, for example, second controller 130 calculates a distance between measuring vehicle 100 and each lighting apparatus 10 based on the calculated angle of view as well as the location information and identification information, which have been obtained by image capturing device 120, of at least two lighting apparatuses 10. Thus, second controller 130 identifies the location of measuring vehicle 100. The location of measuring vehicle 100 calculated by second controller 130 is an absolute location of measuring vehicle 100 and is a relative location which is a location relative to each of lighting apparatuses 10 for which location information has been obtained.

Furthermore, second controller 130 causes flaw detection device 110 to irradiate at least one of the road or the facility adjacent to the road with laser light, and obtains flaw location information which identifies a flaw location on at least one of the road or the facility adjacent to the road. Specifically, at the time when the location of measuring vehicle 100 is identified, second controller 130 outputs, to flaw detection device 110, a control command for causing flaw detection device 110 to irradiate the inner wall of the tunnel with laser light. Second controller 130 causes flaw detection device 110 to irradiate the inner wall of the tunnel with laser light and thereby obtains the flaw location information generated by flaw detection device 110. It should be noted that second controller 130 stores the flaw location information in second memory 140.

Moreover, second controller 130 obtains, from flaw detection device 110, the flaw location information generated by flaw detection device 110, and generates map information by associating, with the flaw location information, the corresponding location in road information which is a map of at least one of the road or the facility adjacent to the road. In other words, in this embodiment, second controller 130 associates the flaw location information with the road information indicating the inner structure of the tunnel, by plotting the flaw location information generated by flaw detection device 110 on the road information. Thus, second controller 130 generates three-dimensional map information indicating the inner structure of the tunnel, in which the flaw location information is associated with the corresponding location in the road information indicating the inner structure of the tunnel. Since flaw locations, that is, deterioration points, are identified in this map information, by viewing the map information, the user easily recognizes the deterioration points identified on at least one of the road or the facility adjacent to the road. It should be noted that second controller 130 stores the map information in second memory 140.

Moreover, second controller 130 transmits, via communication unit 150, the generated map information to data center 190 such as an autonomous community, a police, a road management company, etc. Thus, a road management company identifies correct flaw locations.

Second controller 130 is achieved, for example, by a processor, a micro computer, or a dedicated circuit. Second controller 130 may be achieved by a combination of two or more of a processor, a micro computer, and a dedicated circuit.

Second memory 140 stores videos captured by image capturing device 120, the identification information of each lighting apparatus 10, the location information of each lighting apparatus 10, map information, etc. Moreover, second memory 140 stores a control program to be executed by second controller 130, or the like.

Communication unit 150 is a wireless communication module that transmits, to data center 190, the map information generated by second controller 130.

Second power source 160 is a component that converts, by means of rectification, smoothing, power reduction, etc., alternating current power supplied from a commercial power source into direct current power having a predetermined level, and that supplies light-emitting module 20 with the direct current power.

### (Operations)

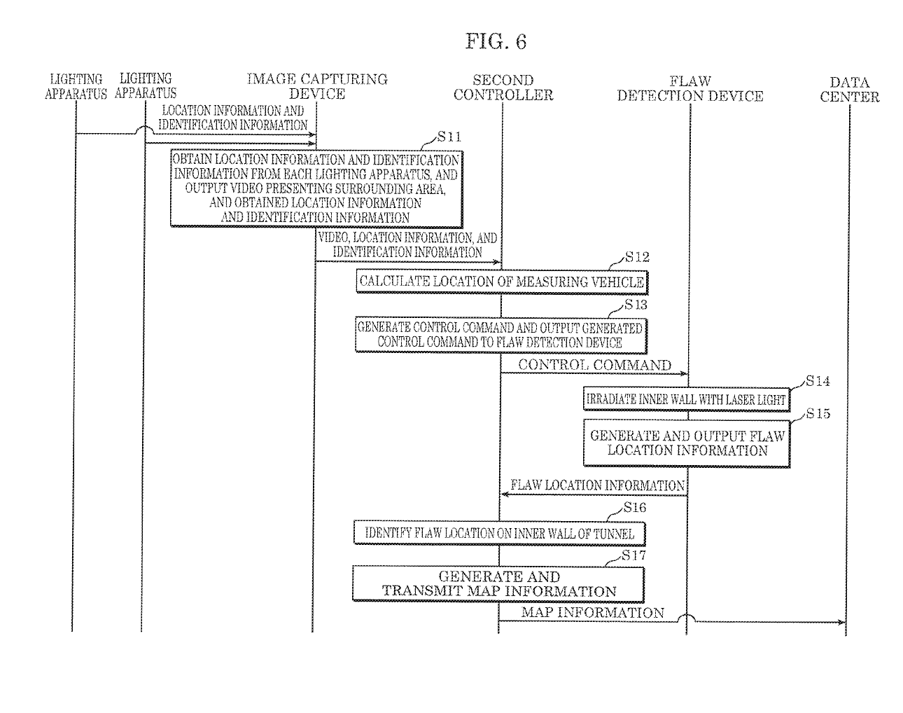

Next, lighting apparatus 10, a method for providing a lighting system, and operations performed by road management system 1 will be described with reference to FIG. 6.

FIG. 6 is a sequence chart illustrating the operations performed by road management system 1 according to Embodiment 1.

FIG. 6 assumes the case where a plurality of lighting apparatuses 10 are installed along the traveling direction of measuring vehicle 100 that travels on a road in a tunnel which is one example of a facility adjacent to a road. It is also assumed that measuring vehicle 100 captures images of the inner wall of the tunnel while traveling on the road, and flaw detection device 110 irradiates the inner wall of the tunnel with laser light. FIG. 6 assumes the case where location information and identification information are obtained from each of two lighting apparatuses 10.

First, image capturing device 120 obtains location information and identification information from each lighting apparatus 10 while measuring vehicle 100 travels on the road (S11). Moreover, image capturing device 120 captures images of the surrounding area of measuring vehicle 100 (S11). Image capturing device 120 outputs, to second controller 130, video presenting the surrounding area of measuring vehicle 100, and the obtained location information and identification information of each lighting apparatus 10 (S11).

Next, second controller 130 calculates the location of measuring vehicle 100 based on the locations of lighting apparatuses 10, each location being indicated by the location information obtained from one of lighting apparatuses 10, the identification information obtained from each lighting apparatus 10, and the video presenting the surrounding area of measuring vehicle 100 (S12). Specifically, second controller 130 calculates an angle of view based on video presenting lighting apparatuses 10, and calculates an absolute location of measuring vehicle 100 and a relative location of each lighting apparatus 10 for which location information has been obtained, based on the calculated angle of view and the location corresponding to the identification information of each lighting apparatus 10.

Second controller 130 then generates a control command for controlling the operation of flaw detection device 110, and outputs the generated control command to flaw detection device 110 (S13). In other words, at the time when the location of measuring vehicle 100 is identified based on the location information obtained from each lighting apparatus 10 etc., second controller 130 outputs a control command to flaw detection device 110 in order to cause flaw detection device 110 to irradiate the inner wall of the tunnel with laser light.

Next, upon the obtainment of the control command from second controller 130, flaw detection device 110 irradiates the inner wall of the tunnel with laser light (S14). With this, flaw detection device 110 determines the state of deterioration of the inner wall of the tunnel. In other words, flaw detection device 110 generates flaw location information which identifies a flaw location on at least one of the road or the facility adjacent to the road, by irradiating at least one of the road or the facility adjacent to the road with laser light while measuring vehicle 100 travels on the road (S15). Flaw detection device 110 then outputs the generated flaw location information to second controller 130 (S15).

Being capable of calculating, for example, an angle at which the inner wall of the tunnel is irradiated with laser light with respect to a horizontal direction, based on the location and tilt of measuring vehicle 100, second controller 130 subsequently identifies a flaw location on the inner wall of the tunnel. In other words, second controller 130 identifies a correct flaw location of a deteriorating part on the inner wall of the tunnel (S 16). Second controller 130 stores, in second memory 140, flaw location information indicating a flaw location on the inner wall of the tunnel.

Second controller 130 subsequently adds the flaw location to the corresponding location in the road information stored in second memory 140. Second controller 130 adds all of flaw locations to the road information, and thereby generates map information in which the flaw locations are identified on the inner wall of the tunnel (S17). Second controller 130 stores, in second memory 140, the map information in which the flaw locations are identified.

Second controller 130 then transmits, to data center 190 via communication unit 150, the map information in which the flaw locations are identified (S17). Then, the processing returns to the beginning.

### (Operational Advantages)

Next, the operational advantages of lighting apparatus 10, of the method for providing a lighting system, and of road management system 1 according to this embodiment will be described.

As has been described above, lighting apparatus 10 according to this embodiment irradiates measuring vehicle 100 with light. Lighting apparatus 10 includes: light-emitting module 20 that emits light for illuminating a predetermined area; first memory 71 that stores location information indicating the location of lighting apparatus 10; location information notifying element 30 that outputs, to the predetermined area, a light signal indicating location information; and first controller 70 that controls light-emitting module 20 and location information notifying element 30, and modulates the light signal output by location information notifying element 30, in accordance with the location information stored in first memory 71.

According to this, first memory 71 stores the location information indicating the location of lighting apparatus 10. Location information notifying element 30 outputs, to a predetermined area, a light signal indicating the location information of lighting apparatus 10. First controller 70 controls light-emitting module 20 and location information notifying element 30, and modulates the light signal output by location information notifying element 30, in accordance with the location information. Therefore, measuring vehicle 100 having obtained the location information from lighting apparatus 10 knows how far in meters from the entrance of the tunnel the self-vehicle is located, for example, by calculating the location of the self-vehicle based on the location information of lighting apparatus 10. Thus, with the obtainment of the location information etc. from lighting apparatus 10, measuring vehicle 100 becomes capable of easily identifying deterioration points on at least one of the road or the facility adjacent to the road.

Accordingly, with this lighting apparatus 10, it is possible to improve the workability of the work for identifying deterioration points on at least one of a road or a facility adjacent to the road.

Moreover, road management system 1 according to this embodiment includes: lighting apparatus 10; image capturing device 120 that is equipped in vehicle 100 and captures an image of a surrounding area of the vehicle; and flaw detection device 110 that generates flaw location information which identifies a flaw location on at least one of a road or a facility adjacent to the road, by irradiating at least one of the road or the facility adjacent to the road with laser light while the vehicle travels on the road.

Even in this case, the same operational advantages as described above are obtained.

Moreover, lighting apparatus 10 according to this embodiment further includes housing case 50 that houses at least light-emitting module 20 and location information notifying element 30 and that has opening 50a through which light passes. When opening 50a is viewed in a plan view, location information notifying element 30 is disposed at the center of opening 50a.

When lighting apparatus 10 is large, for example, inaccuracy in the location of lighting apparatus 10 might occur due to its size. When opening 50a is viewed in a plan view, however, location information notifying element 30 is disposed at the center of opening 50a. Therefore, with location information notifying element 30 that outputs location information indicating the center of opening 50a, the inaccuracy due to the size of lighting apparatus 10 hardly occurs. This enables measuring vehicle 100 to accurately identify the location of lighting apparatus 10.

Moreover, according to lighting apparatus 10 of this embodiment, the light signal that is output by location information notifying element 30 is an infrared light signal.

When using visible light for a light signal to be output by location information notifying element 30 in the case of using lighting apparatus 10 under the environment where sunlight enters, the S/N ratio of the light signal is lowered because the sunlight is strong. Using infrared light that is hardly affected by sunlight therefore increases the S/N ratio of the light signal. Accordingly, lighting apparatus 10 is capable of causing measuring vehicle 100 to receive a light signal that is output by location information notifying element 30.

Moreover, the method, according to this embodiment, for providing a lighting system includes: providing a plurality of lighting apparatus 10 along a road at predetermined intervals along a traveling direction of vehicle 100; and outputting, by each of the plurality of lighting apparatuses 10, identification information which identifies lighting apparatus 10 and is stored in first memory 71, to the predetermined area via location information notifying element 30.

According to this method, in the case of installing a plurality of lighting apparatuses 10, identification information for identifying each of lighting apparatuses 10 is received. This enables the identification of each lighting apparatus 10 based on each piece of identification information received, and it is thus possible to identify the location of each lighting apparatus 10. Moreover, in road management system 1 according to this embodiment, a plurality of lighting apparatuses 10 are installed on a road at predetermined intervals along the traveling direction of measuring vehicle 100. Moreover, road management system 1 further includes second controller 130 equipped in measuring vehicle 100. Second controller 130: identifies a location of each of the plurality of lighting apparatuses 10 based on identification information which identifies each of the plurality of lighting apparatuses 10 and is obtained from each of the plurality of lighting apparatuses 10 by image capturing device 120; identifies a location of measuring vehicle 100 based on the location information of at least two of the plurality of lighting apparatuses 10 and video that presents the plurality of lighting apparatuses 10 and is captured by image capturing device 120; causes flaw detection device 110 to irradiate the road and the facility adjacent to the road with laser light, and obtains the flaw location information generated by flaw detection device 110; and generates map information by associating the flaw location information with the corresponding location in road information indicating a map of at least one of the road or the facility adjacent to the road.

According to this system, second controller 130 identifies the location of each of the plurality of lighting apparatuses 10 based on the identification information which identifies each of the plurality of lighting apparatuses 10 and is obtained from each of the plurality of lighting apparatuses 10 by image capturing device 120. Second controller 130 subsequently identifies the location of measuring vehicle 100 based on the location information of at least two of the plurality of lighting apparatuses 10 whose locations have been identified and the video that presents lighting apparatuses 10 and is captured by image capturing device 120. Then, second controller 130 causes flaw detection device 110 to irradiate at least one of the road or the facility adjacent to the road with laser light. With this, flaw detection device 110 obtains flaw location information which identifies a flaw location on at least one of the road or the facility adjacent to the road. Next, second controller 130 generates map information by associating this flaw location information with the corresponding location in the road information indicating a map of at least one of the road or the facility adjacent to the road. Since flaw locations are identified in this map information, flaw locations need not be identified again after the measurement of the flaw locations, unlike a conventional case. Accordingly, with road management system 1, it is possible to improve the workability of the work for identifying flaw locations on at least one of a road or a facility adjacent to the road.

With the installation of a plurality of lighting apparatuses 10 in a facility, in particular, it is possible for image capturing device 120 to obtain the location information of lighting apparatus 10 more in number, and this allows measuring vehicle 100 to calculate a flaw location more correctly. In road management system 1 according to this embodiment, light-emitting module 20 includes LED elements disposed in a matrix on substrate 23. Moreover, in road management system 1 according to this embodiment, location information indicates an absolute position or a relative position of lighting apparatus 10.

Lighting apparatus 10 according to this embodiment irradiates measuring vehicle 100 with light. Lighting apparatus 10 includes: light-emitting module 20 that emits light for illuminating a predetermined area; first memory 71 that stores location information indicating the location of lighting apparatus 10; location information notifying element 30 that outputs, to the predetermined area, a light signal indicating location information; and first controller 70 that controls light-emitting module 20 and location information notifying element 30, and modulates the light signal output by location information notifying element 30, in accordance with the location information stored in first memory 71.

In road management system according to this embodiment, first controller 70 is a processor.

### Embodiment 2

The following describes lighting apparatus 10, a method for providing a lighting system, and road management system 1 according to this embodiment.

### (Configuration)

Although location information notifying element 30 is disposed at the center of lighting apparatus 10 in Embodiment 1, this embodiment differs from Embodiment 1 in that second controller 130 calculates the center point of lighting apparatus 10 and identifies the location of each lighting apparatus 10. Unless stated otherwise, lighting apparatus 10, the method for providing a lighting system, and the configuration of road management system 1 according to this embodiment are the same as described in Embodiment 1. Moreover, like elements share like reference signs in the drawings, and repeated detailed description of like elements will be omitted.

Location information notifying element 30 is an LED element that outputs, to a predetermined area, a light signal indicating location information. In this embodiment, location information is notified by the modulation of substantially all of LED elements of light-emitting module 20, that is, by causing the entirety of light-transmissive panel 40 of lighting apparatus 10 to light. The LED element according to this embodiment outputs, to a predetermined area, a light signal indicating location information. The LED element outputs a visible light signal which has been modulated in accordance with location information by first controller 70.

Second controller 130 calculates the center point of lighting apparatus 10 and identifies the location of each lighting apparatus 10. The location of each lighting apparatus 10 may be deviated from the center in some cases. Second controller 130 therefore obtains size information of each lighting apparatus 10, which is previously stored in second memory 140, and calculates the center point of each lighting apparatus 10 captured by image capturing device 120. Second controller 130 corrects, for each of lighting apparatuses 10, the location indicated by the location information of lighting apparatus 10 to the location indicated by the calculated center point. Second controller 130 thus identifies a correct location of each lighting apparatus 10.

Although it was necessary, in Embodiment 1, to change the spectrum, the peak wavelength in particular, of LED element 22 to be different from the spectrum of location information notifying element 30, in order to increase the S/N ratio of a light signal, it should be understood that, in this embodiment, LED elements having an identical spectrum may be used because all of LED elements are modulated at the same time. Moreover, since the center point of lighting apparatus 10 is calculated based on the entirety of lighting apparatus 10, it is possible to receive the location information of lighting apparatus 10 by pixels in image capturing device 120 even when measuring vehicle 100 is located relatively distant from lighting apparatus 10. In this way, it is possible to calculate a distance between measuring vehicle 100 and lighting apparatus 10 in this embodiment. Road management system 1 according to this embodiment may be a system in which the location information of lighting apparatus 10 is notified together with the size information of lighting apparatus 10 by location information notifying element 30 instead that the size information of lighting apparatus 10 is obtained from second memory 140.

### (Operations)

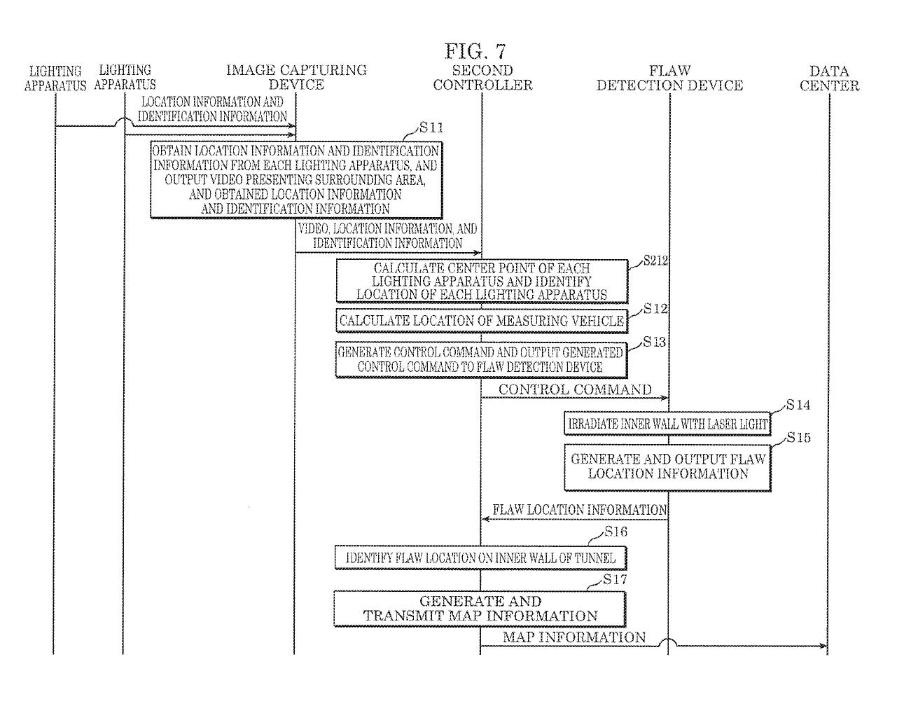

The following describes, with reference to FIG. 7, lighting apparatus 10, a method for providing a lighting system, and operations performed by road management system 1.

FIG. 7 is a sequence chart illustrating the operations performed by road management system 1 according to Embodiment 2.

In FIG. 7, the description of the processing identical to that illustrated in FIG. 6 of Embodiment 1 is omitted where necessary.

First, image capturing device 120 obtains location information and identification information from at least two lighting apparatuses 10 while measuring vehicle 100 travels on a road (S11). Image capturing device 120 outputs, to second controller 130, the obtained location information and identification information of each lighting apparatus 10 (S11).

Next, second controller 130 obtains the size information of each lighting apparatus 10, which is previously stored in second memory 140, and calculates the center point of each lighting apparatus 10 captured by image capturing device 120. Second controller 130 corrects, for each of lighting apparatuses 10, the location indicated by the location information of lighting apparatus 10 to the location indicated by the calculated center point. Second controller 130 thus identifies a correct location of each lighting apparatus 10 (S212).

Subsequently, second controller 130 calculates the location of measuring vehicle 100 based on the location information obtained from each lighting apparatus 10 (S12).

Then, second controller 130 generates a control command for controlling the operation of flaw detection device 110 and outputs the generated control command to flaw detection device 110 (S13).

Next, flaw detection device 110 irradiates the inner wall of a tunnel with laser light (S14).

Subsequently, flaw detection device 110 generates flaw location information which identifies a flaw location on at least one of the road or a facility adjacent to the road, and outputs the generated flaw location information to second controller 130 (S15).

Next, second controller 130 identifies a correct location of a deteriorating part on the inner wall of the tunnel (S16).

By adding all of flaw locations to the map information, second controller 130 generates map information in which the flaw locations are indicated on the inner wall of the tunnel, and transmits the generated map information to data center 190 via communication unit 150 (S17). Then, the process returns to the beginning.

### (Operational Advantages)

The following describes the operational advantages of lighting apparatus 10, of the method for providing a lighting system, and of road management system 1 according to this embodiment.

As has been described above, second controller 130 calculates the center point of each lighting apparatus 10 and identifies the location of each lighting apparatus 10, based on the video that presents lighting apparatuses 10 and is captured by image capturing device 120.

With this, second controller 130 calculates the center point of each lighting apparatus 10 and identifies the location of each lighting apparatus 10, based on the video that presents lighting apparatuses 10 and is captured by image capturing device 120. Second controller 130 is thus capable of correctly calculating the location of each lighting apparatus 10.

The same operational advantages achieved with Embodiment 1 are also achievable with this embodiment.

### (Other Variations, Etc.)

Although the present disclosure has been described based on Embodiments 1 and 2, it should be understood that the present disclosure shall not be limited to Embodiments 1 and 2.

According to the lighting apparatus and the road management system illustrated in each of Embodiments 1 and 2, for example, the lighting apparatus may include an input receiver. Location information indicating, for example, latitude and longitude at which a lighting apparatus is installed may be input to the input receiver. Moreover, identification information for identifying a lighting apparatus at the time of delivery and location information indicating a location at which a lighting apparatus is to be installed may be previously stored in the first memory.

Moreover, according to the lighting apparatus, the method for providing a lighting system and the road management system illustrated in each of Embodiments 1 and 2, the first memory may store only identification information and each of the lighting apparatuses may only transmit identification information. In this case, the second memory may store a table which indicates the location of each lighting apparatus, in which the location of a lighting apparatus is associated with the identification information of the lighting apparatus. In other words, upon receiving identification information from each lighting apparatus, the second controller of the measuring vehicle may identify the location of each lighting apparatus by reading the location information associated with the received identification information, from the table which indicates the location of each of the lighting apparatuses and is stored in the second memory. In other words, location information may also include indirect information such as identification information associated with location information.

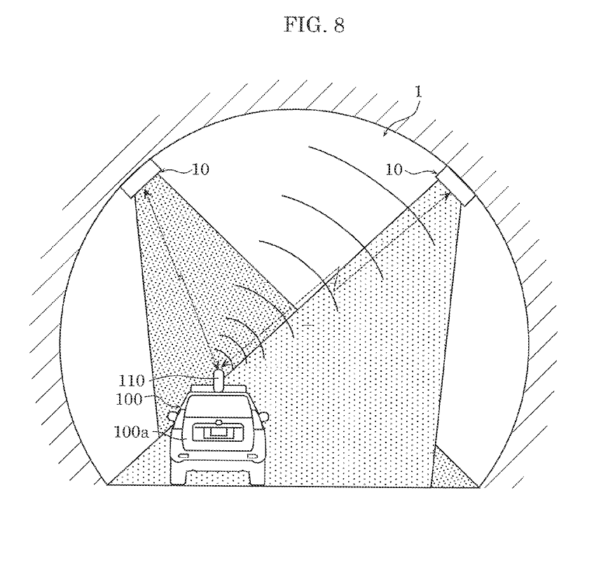

Moreover, according to the lighting apparatus, the method for providing a lighting system and the road management system illustrated in each of Embodiments 1 and 2, a plurality of the lighting apparatuses may be installed in a facility such as the inner wall of a tunnel, as illustrated in FIG. 8. FIG. 8 is a schematic diagram illustrating the case where the measuring vehicle, the lighting apparatuses, and the road are viewed in the traveling direction of the measuring vehicle in a road management system according to a variation. As illustrated in FIG. 8, the lighting apparatuses may be installed on both sides of the measuring vehicle along the traveling direction of the measuring vehicle.

Moreover, according to the lighting apparatus, the method for providing a lighting system, and the road management system illustrated in each of Embodiment 1 and 2, although a distance between the measuring vehicle and the lighting apparatus is obtained based on an angle of view of the image capturing device, it should be understood that the distance may be obtained using a TOF camera.

Moreover, according to the lighting apparatus, the method for providing a lighting system, and the road management system recited in each of Embodiment 1 and 2, although the locations of deteriorating parts on a facility are identified by correctly knowing the location of the measuring vehicle with the use of the lighting apparatuses, it should be understood that the lighting apparatuses may be used for a different purpose that is more effective for identifying the location of the measuring vehicle. The lighting apparatuses may be used, for example, for vehicle navigation for repairing deteriorating parts at a later date after the deteriorating parts have been identified.

Moreover, each of the processing units included in the lighting apparatus, the method for providing a lighting system, and the road management system according to each of Embodiments 1 and 2 is typically realized as an LSI which is an integrated circuit. These circuits may be individually realized as one chip or may be realized as one chip including part or all of the circuits.

Further, each of the processing units to be realized as an integrated circuit is not limited to LSI and may be realized as a dedicated circuit or a general-purpose processor. A field programmable gate array (FPGA) which can be programmed after an LSI is manufactured or a reconfigurable processor which can reconfigure connection or setting of circuit cells inside an LSI may be used.

Note that in each of Embodiments 1 and 2, each component may be configured by dedicated hardware or may be realized by executing a software program suitable for each component. Each component may be realized by causing a program executing unit such as a CPU or a processor to read a software program recorded on a recording medium such as a hard disk or a semiconductor memory and execute the software program.

Moreover, all the numbers used above are exemplary numbers to specifically describe the present disclosure, and the present disclosure is not limited to the illustrated numbers.

Further, division of a functional block in each block diagram is an example, and plural functional blocks may be realized as one functional block, one functional block may be divided into plural functional blocks, or part of functions may be transferred to another functional block. Besides, single hardware or software may process, in parallel or by way of time division, functions of plural functional blocks having similar functions.

Furthermore, an order to execute each step in the flowchart is an exemplary order for specifically describing the present disclosure, and may be other than the above-described order. Furthermore, part of the above-described steps may be executed at the same time as (in parallel to) the execution of other steps.

Embodiments arrived at by a person skilled in the art making various modifications to any one of Embodiments 1 and 2 as well as embodiments realized by arbitrarily combining elements and functions in Embodiments 1 and 2 which do not depart from the essence of the present disclosure are included in the present disclosure.

What is claimed is:

1. A lighting apparatus that irradiates a vehicle with light, the lighting apparatus comprising:
a first light source that emits light for illuminating a predetermined area;
a memory that stores location information indicating a location of the lighting apparatus;
a second light source that outputs, to the predetermined area, a light signal indicating the location information; and
a first controller that controls the first light source and the second light source, and modulates the light signal output by the second light source, in accordance with the location information stored in the memory.

2. The lighting apparatus according to claim 1, further comprising:
a housing that houses at least the first light source and the second light source, and includes an illumination window through which light passes, wherein
when the illumination window is viewed in a plan view, the second light source is disposed at a center of the illumination window.

3. The lighting apparatus according to claim 1, wherein
the light signal that is output by the second light source is an infrared light signal.

4. The lighting apparatus according to claim 1, wherein
the first light source includes a substrate and light emitting diode elements disposed in a matrix on the substrate.

5. The lighting apparatus according to claim 1, wherein
the location information indicates at least one of an absolute position or a relative position of the lighting apparatus.

6. The lighting apparatus according to claim 1, wherein
the first controller is a processor

7. A lighting apparatus that irradiates a vehicle with light, the lighting apparatus comprising:
a light source that emits light for illuminating a predetermined area;
a storage that stores location information indicating a location of the lighting apparatus;
a location information notifying element that outputs, to the predetermined area, a light signal indicating the location information; and
a first controller that controls the light source and the location information notifying element, and modulates the light signal output by the location information notifying element, in accordance with the location information stored in the storage.

8. A method for providing a lighting system, the method comprising:
providing a plurality of the lighting apparatus according to claim 1 along a road at predetermined intervals along a traveling direction of the vehicle; and
outputting, by each of the plurality of the lighting apparatus, identification information identifying the lighting apparatus to the predetermined area via the second light source, the identification information being stored in the memory.

9. A road management system, comprising:
the lighting apparatus according to claim 1;
a camera that is in the vehicle and captures an image of a surrounding area of the vehicle; and
a third light source that generates flaw location information by irradiating at least one of a road or a facility adjacent to the road with laser light while the vehicle travels on the road, the flaw location information identifying a flaw location on the at least one of the road or the facility adjacent to the road.

10. The road management system according to claim 9, wherein
a plurality of the lighting apparatus is provided along the road at predetermined intervals along a traveling direction of the vehicle,
the road management system further comprises:
a second controller in the vehicle, and
the second controller:
identifies a location of each of the plurality of the lighting apparatus based on identification information obtained from each of the plurality of the lighting apparatus by the camera, the identification information identifying each of the plurality of the lighting apparatus;
identifies a location of the vehicle based on the location of at least two of the plurality of the lighting apparatus and on video of the plurality of the lighting apparatus that is captured by the camera;
obtains the flaw location information generated by the third light source; and
generates map information by associating the flaw location information with a corresponding location in road information indicating a map of at least one of the road or the facility adjacent to the road.

11. The road management system according to claim 10, wherein
the second controller calculates a center point of each of the plurality of the lighting apparatus and identifies the location of each of the plurality of the lighting apparatus, based on the video of the plurality of the lighting apparatus that is captured by the camera.
